(19) United States
(12) Patent Application Publication
(10) Pub. No.: US 2005/0268235 A1
(43) Pub. Date: Dec. 1, 2005

(54) Video system for grave stones

(76) Inventor: Marah Ann Stone, Proberta, CA (US)

Correspondence Address: MARAH ANN STONE, 25195 2nd Ave., LOS MOLINOS, CA, 96055, US

(21) Appl. No.: 10/979,289

(22) Filed: Apr. 25, 2005

Related U.S. Application Data
(60) Provisional application No. 60/517,500, filed on Nov. 6, 2003.

(51) Int. Cl. G11B 27/00

(52) U.S. Cl. 715/716

(57) ABSTRACT

This Utility can be located at any location within the gravestone and stores videos and pictures on a hard drive, which displays them on the screen. This system is inset within a sealed, weatherproof L-4 box, which protects it from weather and dust. It is also kept from harms way and accessible by owner. Video system is powered by 9.5 volts DC and holds charge with a custom made solar panel located on gravestone top in which the panel includes a blocking diode inline. This blocking diode keeps the systems battery from discharging when the sun is gone. System can run 4 hours of video at one use before recharging. Included with system is an easy access USB hookup, which can be located on back or side to upload additional videos using a laptop. Also included are speakers with great sound located below display inside the same sealed L-4 box.

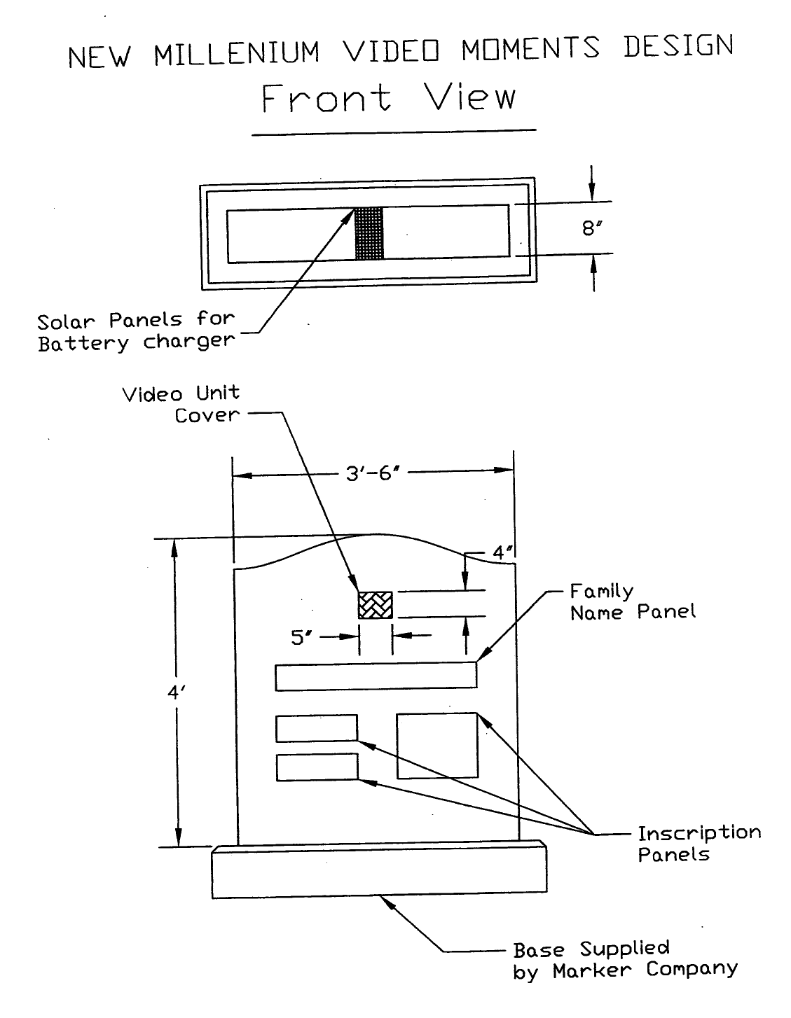

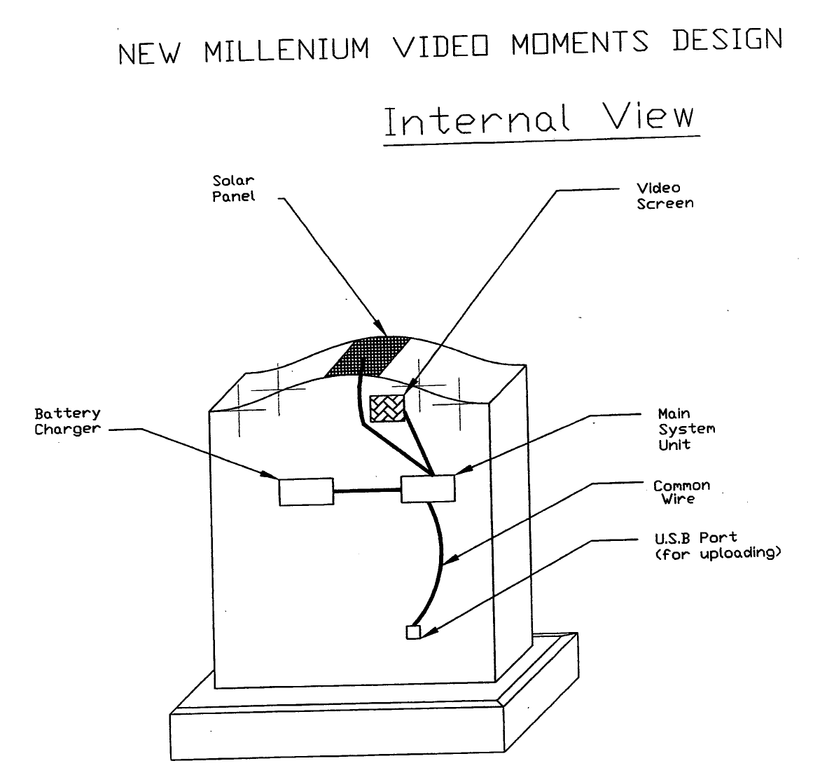

This Utility is for showing video pictures stored on a hard drive And shown on a Video screen in gravestones. The video screen is located in middle location of Gravestone, inset in the stone within a weather-protected L-4 box with wiring for system Located inside gravestone.

System is powered by 9.5 volts DC and is kept charged with a solar panel located on top of stone, which has a blocking diode inline. The system can run up to 4 hours of streaming video at one use before having to be recharged automatically by its charger. A USB plug is located on back of gravestone for up loading pictures from a portable laptop PC. System includes a sound system located under screen inside the system-boxed compartment.

The weatherproof box that stores system has a cover that is accessible by owner of System and is kept clean and from harms way.

1. Video system showing video pictures on a screen visible to owner, installed into a gravestone marker.

2. I am the sole inventor and there is no other idea like this except Mine.
